(19) United States
(12) Patent Application Publication
(10) Pub. No.: US 2023/0033738 A1
(43) Pub. Date: Feb. 2, 2023

(54) Children's Easel for Advanced Color-Mixing

(71) Applicant: Margarete Judy Cook, Barrytown, NY (US)

(72) Inventor: Margarete Judy Cook, Barrytown, NY (US)

(21) Appl. No.: 17/391,953

(22) Filed: Aug. 2, 2021

(51) Int. Cl. B44D 3/04

(52) U.S. Cl. CPC B44D 3/04

(57) ABSTRACT

A children's painting easel, for use with tempera (poster) paint, the function of which is to present black, blue, red, yellow, white and sometimes turquoise tempera paint in individual shallow paint wells with additional wells for mixing colors while providing a securely fitted water container next to which is located a sponge. These components are presented using a shelf located at the bottom of the body of the easel and which combine to enable the easy mixing of a wide variety of paint colors while also allowing for easy cleaning.

### CROSS-REFERENCE TO RELATED APPLICATIONS

not applicable

### FEDERALLY SPONSORED RESEARCH AND DEVELOPMENT

not applicable

### SEQUENCE LISTING

not applicable

### BACKGROUND OF THE INVENTION

This invention relates to children's painting easels—specifically it relates to easels that can accommodate a painting assemblage which facilitates the ability to mix tempera paint colors.

The illustration below shows a typical example of a free-standing children's painting easel commonly used in either a classroom or home setting. The painting assemblage consists of a large tray with high sides to hold tempera (poster) paint containers for tempera (poster) paint. These paint containers are usually covered with ‘no-spill’ lids, each with a small hole in the lid to hold a single brush.

The problems with this assemblage are:
1. The deep tray is hard to clean
2. The paint is generally covered up by no-spill lids so that children can not see it.

This creates an assemblage that:
(a) stops children being able to make thoughtful choices about the colors they want to use as they can not properly see the colors.
(b) is not fully inviting to young children as they are not able to see and experience the paint in an immediate and visceral way.
3. To change their paint color using this assemblage children need to let go of one brush to pick up a different brush. This is something that very young children are often reluctant to do and which can be hard for them to coordinate.
4. Children are not offered a water container with this assemblage. This means they can not use water to vary the opacity of the paint or to wash their brush.
5. Most importantly: this assemblage does not allow children to easily mix the paint.

When children mix different paint colors together on their paper using this assemblage they end up with a brush containing a color which, when returned to the paint container, contaminates the original color inside. Children then no longer have ‘clean’ color to use and are no longer able to make clear choices about color-mixing. The ability for children to gain skill in color-mixing, and to develop their personal expression through color, is thus curtailed.

Attempts to solve this problem have been made by giving children a variety of pre-mixed colors such as orange, green and purple. However, offering pre-mixed color removes the thrill children experience when making colors for themselves. Indeed, for some children, the magic of mixing color is often the primary motivation behind painting. Mixing with pre-mixed colors such as green and purple mostly produces fairly dull tertiary colors.

Pre-mixed colors also do not allow children to control the shade or tone of the color that they want to use, for example: pale pink rather than bright pink, military green rather than grass green, leaving children unable to discover, explore and develop their individual color preferences.

Additionally, color-mixing that does occur using this assemblage can only happen by mixing the paint on the paper. Mixing paint on the paper of an upright easel can be hard to do as large amounts of paint will drip if applied to it. As a child gains awareness and skill in mixing color, they also often want to mix a color first before putting it on the paper. With a typical painting assemblage there is no separate mixing area for children to use.

Progressive teaching schools such as Bank Street College and Teacher's College have solved some of these problems by doing ‘table-top painting’ rather than using easels. They place trays next to the paper (see below for illustration). These trays contain individual rubber castor cups holding the primary colors plus black and white, a water container and a sponge. The cups hold a small amount of paint and get washed after each use. This way fresh paint can be provided for each painting session. Children can use the water container to clean their brush so that they can use a single brush and do not need to let go of the brush to change colors.

There are some draw-backs to table top painting:
1. When children want to mix a color before putting it on their paper the only option is to mix color on the surface of the large baking tray. This is not satisfactory as tempera is not thick like acrylic or oil paint and simply spreads into a large pool on the tray making it hard to pick up with a brush.
2. It is not possible to step back and view the painting from a distance when the paper is lying on a table, making it hard for children to see more clearly the marks they have made with the brush.
3. It can be hard for small children to reach the top of a large piece of paper when it is lying on a table top.
4. The level of sensitivity to the touch of the paint brush is reduced when young children are not able to move their whole bodies backwards or forwards easily from their painting to control the pressure of the brush.
5. Children tend to get clothing messy with table top painting as sleeves fall into paint or they lean over their wet painting.
6. Not many classrooms have enough space for table top painting and using table top space often does not allow teachers or parents to leave the option to paint open throughout the day.
7. Because very young children do not yet have a lot of fine motor control they usually use the whole of their arm when they move the paint brush. If they are working on a table top it is harder for them to freely move or swing their arm the way they can if using an upright easel. Being able to swing their arm and feel a brush full of paint glide easily across the surface of the paper is an important, fun and motivating sensory experience for young children.

Additional disadvantages of prior art:
1. There are few ways teachers can set up painting outside for large groups of children using free standing easels, few of which can be left outside in all seasons or which are easy and practical to use outside.
2. Do not fit easily in small apartments.
3. Are generally bulky and take up storage space when not in use.
4. Are not made to be aesthetically pleasing
5. Are not fitting for use in kitchens where clean up is often easiest.

### BACKGROUND OF THE INVENTION—OBJECTS AND ADVANTAGES

Accordingly, the advantages of my invention are to:

Provide an easel fully conducive to easily mixing paint in ways that may include:
1. Providing trays which are designed with individual wells to contain tempera paint in the primary colors, black, white (and turquoise for older children) so that children can mix a large array of colors.
2. Providing trays designed to contain an amount of paint sufficient for a single painting session.
3. Providing trays with additional wells to mix paint.
4. Providing a secure place to hold a water container so that children can wash their brush between colors or to use the water to adjust the opacity of the paint.
5. Providing a place for a sponge to absorb excess water from the brush after washing.
6. Providing trays designed to make it easy to supply fresh paint for each painting session.

Provide an easel that is easy to clean in ways that may include:
1. Providing super smooth trays.
2. Providing components that are easily removable, yet which grip together by virtue of their material construction using no fasteners, though these can easily be added if extra security is needed.
3. Using attachments that allow it to be easily unhooked from a wall, a fence, a large window, or a refrigerator.
4. Enabling it to be attached to refrigerators and used in kitchens or other places conveniently near to a sink.
5. Simplifying the construction to create few parts to clean.

Create an inviting set-up in ways that may include:
1. Allowing children an immediate and visceral experience of the paint by not covering the paint.
2. Allowing fresh paint to easily be provided.
3. Enabling it to be placed at the right height and in the most convenient place for painting.
4. Providing an easel made by such material as is easily customized to produce an aesthetically pleasing result.

Provide a developmentally-appropriate easel in ways that may include:
1. Allowing young children to use a single brush.
2. Allowing young children to use large motor movements with ease to make marks with the brush.
3. Allowing children to view their work from a distance.
4. Allowing children to mix their own colors.
5. Allowing children to mix color in convenient mixing wells.

Other Objects and Advantages are to:
1. Provide an easel that may be compact and easy to store.
2. Provide an easel that could be easily mounted on a wall, fence, refrigerator, or any vertical surface, indoors or outdoors.
3. Provide an easel that could be left outdoors in most weather.
4. Provide an easel that, when used in it's wall-hanging embodiment, could be left in place ready for painting without impinging on other activities or restricting floor space.
5. Provide an easel that could be made cheaply, allowing the purchase of multiples so that teachers may paint outdoors with large groups of children.
6. By using clear/transparent material outdoor easels may not visually interrupt the landscape.
7. Provide an easel which could be both attractive and highly functional.

### SUMMARY

This innovative easel combines the advantages of upright easel painting with the advantages of the more educational and developmentally appropriate assemblage of ‘table top’ painting as used in progressive teaching schools. It provides a way for children to use an upright easel with a fresh set of tempera paint colors (specifically black, blue, red, yellow and white) each time they paint so that they can make clear decisions about color-mixing and mix a wide variety of colors. Children are able to keep their paint colors uncontaminated by using the water container to wash their brush. The easel is designed in such a way as to maximize convenience of use while also being an attractive and inviting educational product.

### DRAWING FIGURES

FIG. 1 shows the preferred embodiment of the easel with paint tray, sponge and water container tray, holes for fastening the easel to a vertical surface, and clips to hold paper to the easel.

FIG. 2 shows an exploded view of the easel, to show how the trays fit on the shelf of the easel.

FIG. 3 shows the ¾ side view of an easel with spacers/studs attached. It also shows the bend in the body of the easel which creates the shelf.

FIG. 4 shows the easel without the trays to illustrate how the easel is formed from a single piece of bendable material.

FIG. 5 shows an alternate embodiment of the easel for use indoors or outdoors easel with silicone paint cups and a shallow acrylic tray that is held in place by the water container.

FIG. 6 shows an alternate embodiment of the easel for use outdoors.

FIG. 7 shows an alternate embodiment of the easel in free-standing, rather than wall-hanging, form.

### REFERENCE NUMERALS

20: body of easel
22: paint tray with mixing wells
24: shelf
26: sponge tray with hole for water container
28: grommet surrounding hole for hanging
30: clips to hold paper to the top of the easel
32: paper
34: water container
36: sponge
38: paint brush
40: spacer/stud
42: magnet
44: bend in easel material
46: hole for water container
48: paint well
50: hole
52: end of hook
54: mixing compartment
56: hole in tray 26
58: lip of water container
60: point of contact between 22 and 26
62: back of easel
64: front of easel where 22 and 26 abut
66: shallow paint tray w/mixing wells
68: clips for outdoor use
70: acrylic tray
72: spacer/stud (at back of easel)
74: paint cups
76: bracket hooks
78: metal or wood support structure

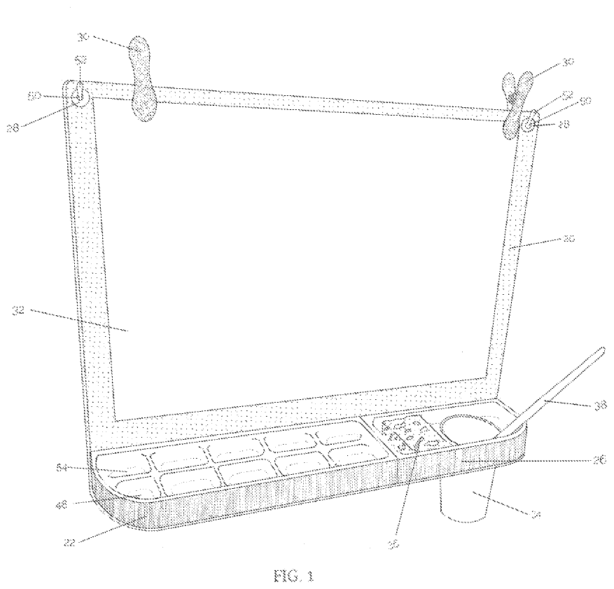

### Description—FIGS. 1-4

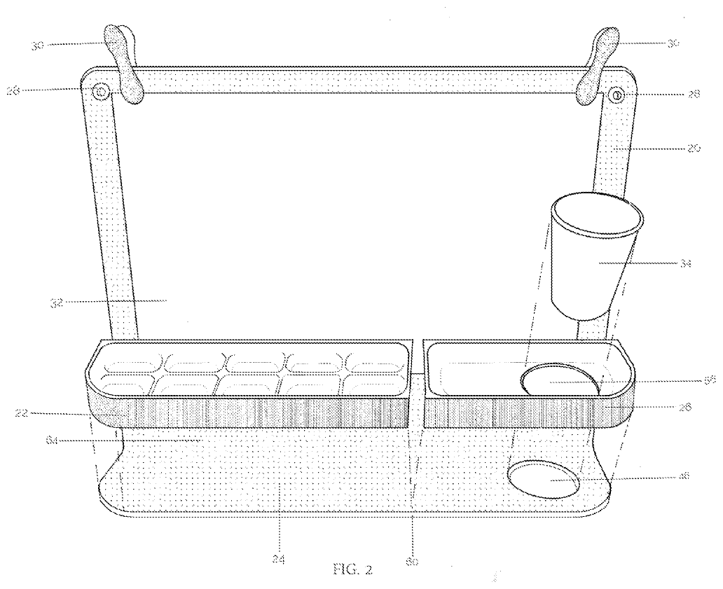

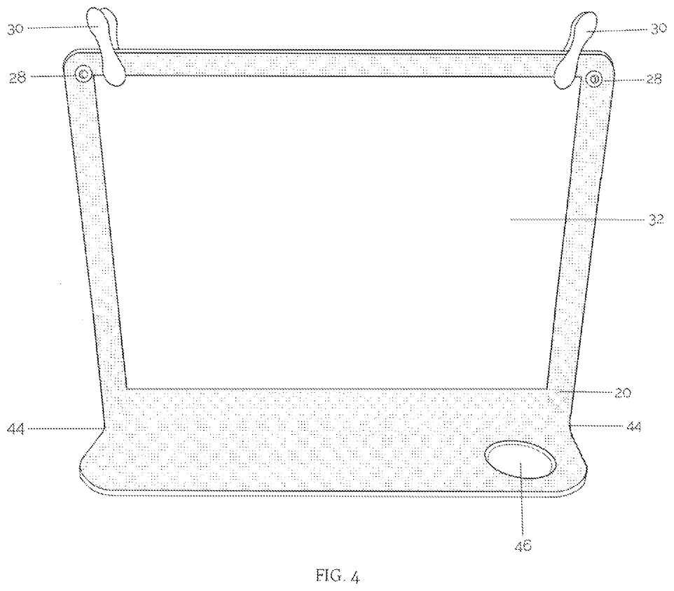

The preferred embodiment of the easel is shown in FIG. 1 (front/side view). The main body of easel 20 is a rectangular piece of plexiglass 0.125 inches thick with one of the long ends bent at 90 degrees to form an approximately 4 inch wide shelf 24 with rounded corners and an approximately 3 inch diameter hole to fit water container 34 on right side (see FIG. 2 or FIG. 4). On left side of shelf 24 sits paint tray 22 made of molded silicone with mixing compartments 46 and five paint wells 47. On the right side of the shelf another tray 26 of molded silicone has an approximately 3 inch diameter hole (see FIG. 2) for water cup 34 and space for sponge 36. Water container 34 is held in place by its outer lip 58 resting on edge of hole 56 (see FIG. 2) in tray 26. At the top of easel 20 are two small holes 50 to use with hooks 52. Grommets 28 surround holes 50. Clips 30 attach paper 32 to top of the easel 20.

FIG. 2 of the preferred embodiment shows how trays 22, 26 fit onto shelf 24. Hole 54 in shelf 24 aligns with hole 56 in tray 22 to allow a water container 34 to fit through holes 54, 56. Silicone trays 22, 26 fit snuggly together at point 60 and against face of easel 20.

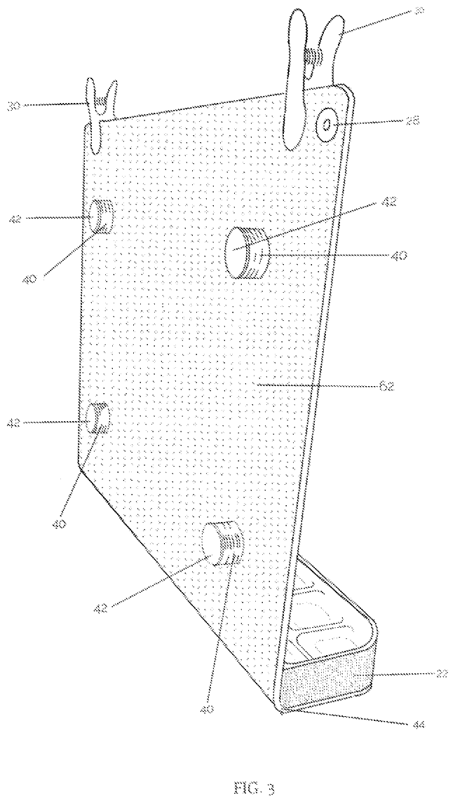

FIG. 3 shows an angled view of back of easel 62 with a small part of left side of shelf 24 visible to show bend 64 which forms shelf 24. FIG. 3 also shows mounted cylindrical spacers/studs 40. These spacers/studs have flat acrylic caps 42 upon which can be stuck disk magnets (for hanging on refrigerators and other metal surfaces), rounds of double sided tape or felt circles (when hanging on walls).

FIG. 4 shows the front of the easel without the trays to emphasize and clarify the easel's basic structure.

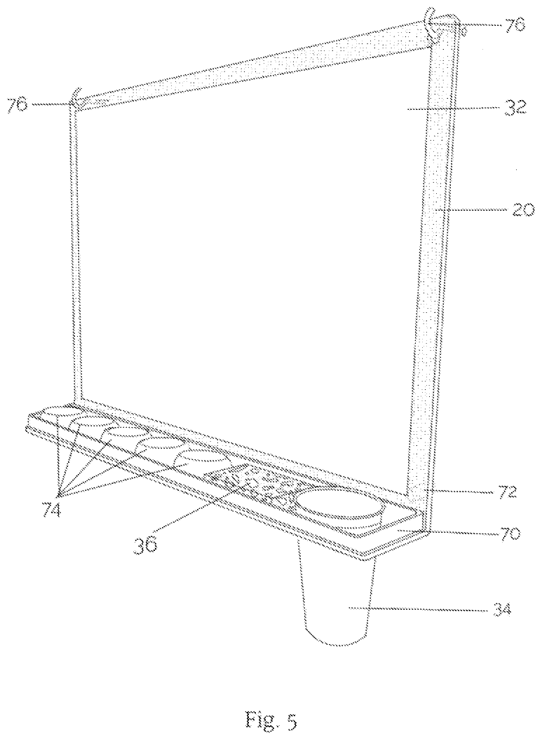

### Description—FIGS. 5-7

FIG. 5 shows an alternate embodiment of the easel. FIG. 5 shows an easel 20 for use indoors with a shallow plastic or acrylic tray which forms a ‘lip’ following the edge of the shelf 24 to catch paint dips. Inside the tray 70 are silicone or rubber cups 74 to hold the paint. These cups can be replaced with a mixing tray 66 if preferred.

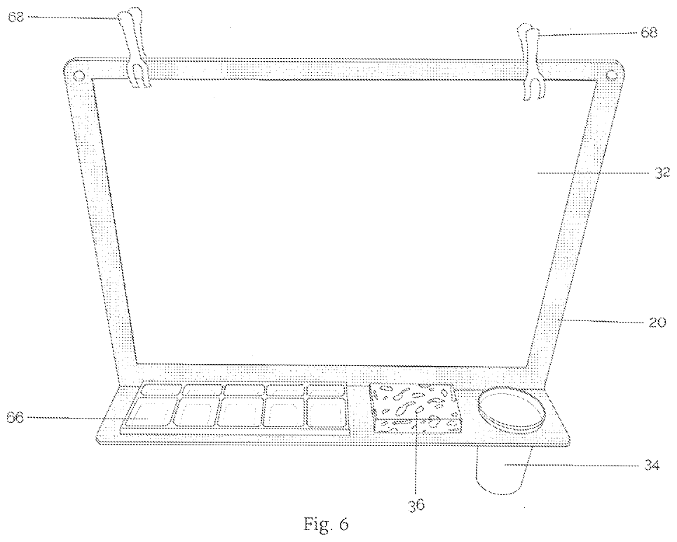

FIG. 6 shows an alternate embodiment of the easel. FIG. 6 shows an easel 20 for use outdoors with a silicone tray 66 which has wells for paint and for mixing paint. This tray 66 grips to the shelf and does not need any attachments. The sides on this tray are level with the paint wells as they do not need to catch drips. The sponge 36 sits directly on the shelf 24. Water container 34 is secured though a hole in shelf 24. Strong clips 68 hold paper 32 tightly on windy days.

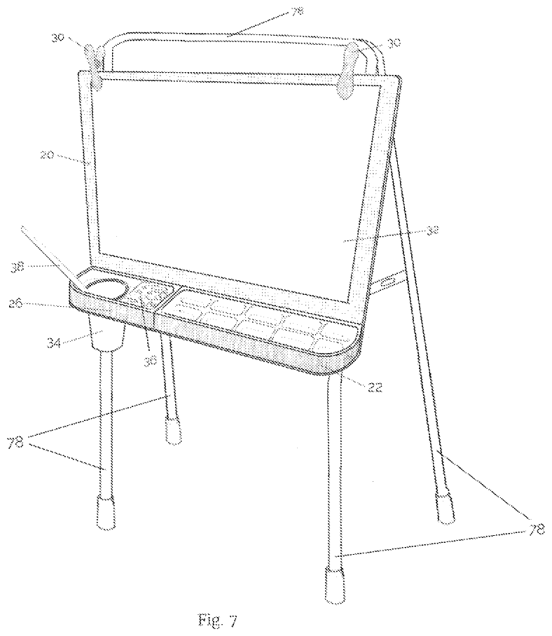

FIG. 7 shows an alternate embodiment of the easel in the form of a free-standing easel. All parts are the same as FIG. 1 except for structure 78 which supports the body of easel 20.

### Operation—FIGS. 1-4

In the preferred embodiment easel 20 is made of bendable, lightweight, shatter resistant plastic such as Polymethyl methacrylate (also known by the trade names Plexiglass, Lucite, Perspex among several others) however it can be made of any material which can be bent without fracturing or on which a shelf can be attached and the surface of which is completely smooth. In this preferred embodiment the trays 22, 26 are made of molded silicone which by the nature of the material grip to the easel, resisting sideways sliding motion and making them easy to lift off for cleaning. The water container 34 sits lower than the shelf 24 to make it convenient to wash brush 38 without having to lift brush 38 and so that water container 34 does not obstruct the painting in any way. Placing the water container into a hole and securing by the lip of the container also makes it convenient to remove easily. Sponge 36 is placed directly to the side of water container 34 so that any excess water left on brush 38 after washing can be patted off. On the back of easel 62 are studs/spacers 40 which hold the easel away from the surface on which it is hanging. When hanging easel 20 on a refrigerator magnets 42 are placed on the ends of studs/spacers 40 and, in conjunction with strong adhesive hooks, magnets 42 hold easel 20 to the surface of the refrigerator.

### Operation—FIGS. 5-7

FIG. 5, this additional embodiment operates in the same way as the preferred embodiment with two differences: a plastic or acrylic tray 70 with an approximately half inch lip (80) and circular silicone paint cups 74. Tray 70 is held in place by water container 34 and can be easily removed for cleaning. It also serves to catch drips and spillage from paint cups 74 and water from sponge 36 or water container 34. As with the preferred embodiment easel 20 in FIG. 5 can be hung by hooks 76 which hold it approximately an inch and a half away from the wall at the top of easel 20 and by same-length studs/spacers 72 at the bottom of easel 20.

FIG. 6 shows easel 20 as it can be used in outdoor settings. Silicone tray 66 differs from tray 22 in the preferred embodiment in that it has lower sides as it does not need to contain paint drips or spillage. Likewise there is no need for a tray such as tray 26 to contain sponge 36 or to surround water container 34.

FIG. 7 shows how easel 20 could be attached to metal or wood support structure 78 to create a free-standing easel. All parts of easel body in FIG. 7 operate in the same way as FIG. 1.

### CONCLUSION, RAMIFICATIONS, SCOPE

The reader can see that these easels are designed to give children a high-quality, educational painting experience by providing them with an assemblage containing the colors they need (black, white and the primary colors) to mix a wide range of new colors. At the same time these easels provide a teacher/parent with a way to easily remove, clean and replace the paint trays or cups so that they can be filled with fresh paint after each use. The easel also provides many additional advantages which contribute to a quality painting experience, including the benefits of an upright painting surface and it's versatile design which allows it to stand or be hung in a variety of environments.

The materials such as the silicone trays and the plexiglass body of the easel which are used in the preferred embodiment are not the only materials that can be used to create this easel. For example, hard plastic trays rather than silicone could be used if attached by clips or other such methods to secure them to the shelf or tray. Adjustments can be made easily such as attaching small silicone studs on the bottom of the tray to fit into holes in the shelf if extra protection against sliding is needed for very young children. The body of the easel could be made with various thickness' of material. The body of the easel could be made out of wood or plastic and the shelf could instead be replaced with a detachable tray. Paint trays do not necessarily need additional mixing wells, especially for very young children. Paint trays could have a covering or ‘lid’ to prevent paint from drying out when not in use. Clips to hold and store extra paper could be added to the back or underside of the easel. Thus the scope should be determined by the appended claims and their legal equivalents, rather than by the examples given.

1. I claim an easel configured to facilitate the mixing of tempera paint comprising:
an easel capable of being situated upright;
a shelf or tray attached or attachable to the easel to house components that provide a way to present a plurality of tempera paint colors in amounts of no more than 2.5 fluid ounces each;
a water container with the capacity to hold at least 8 fluid ounces of water;
means for securing said water container to the easel where said water container hangs lower in its majority than said shelf or tray;
and a space next to said water container for placing absorbent material.
